(19) United States
(12) Patent Application Publication
(10) Pub. No.: US 2008/0154720 A1
(43) Pub. Date: Jun. 26, 2008

(54) SHOPPING ROUTE OPTIMIZATION AND PERSONALIZATION

(75) Inventors: Alexander G. Gounares, Kirkland, WA (US); Lili Cheng, Bellevue, WA (US); David M. Chickering, Bellevue, WA (US); Michael Connolly, Seattle, WA (US); Gary W. Flake, Bellevue, WA (US); Eric J. Horvitz, Kirkland, WA (US); Kamal Jain, Bellevue, WA (US); Christopher A. Meek, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/862,766

(22) Filed: Sep. 27, 2007

Related U.S. Application Data
(60) Provisional application No. 60/870,926, filed on Dec. 20, 2006.

(51) Int. Cl. G01C 21/00; G06F 17/30; G06Q 30/00

(52) U.S. Cl. 705/14; 701/201

(57) ABSTRACT

The claimed subject matter relates to an architecture that can aggregate user information in order to provide shopping route optimization. The architecture can collect data from users or business establishments, and can further make inferences about a user based upon histories, behavior, query responses, as well as from other suitable data sources. By providing the shopping route optimization, the architecture can gain access to rich sets of information, which can in turn improve the optimizations, potentially creating a virtuous cycle.

### CROSS-REFERENCE TO RELATED APPLICATIONS

This application claims the benefit of U.S. Provisional Application Ser. No. 60/870,926, filed Dec. 20, 2006, entitled “ARCHITECTURES FOR SEARCH AND ADVERTISING.” This application is related to U.S. application Ser. No. 11/767,360, filed on Jun. 22, 2007, entitled “MOBILE AD SELECTION AND FILTERING,” and also related to U.S. Application Serial number (MSFTP1733US) ______, filed on ______, entitled “LOAD-BALANCING STORE TRAFFIC.” The entireties of these applications are incorporated herein by reference.

### BACKGROUND

With the meteoric rise of Internet users, advertisers are continually looking for new ways to reach these users with advertisements. Unfortunately, while it is very easy to deliver mass advertisements (e.g., SPAM) by way of Internet advertising, such advertisements are often not relevant to a user since the advertiser may have no information about the user other than an email address. Oftentimes, these advertisements are viewed as annoyances, resulting in potential loss of goodwill, and/or are commonly filtered or immediately deleted. Advertisements that are tailored in some way for a user are generally less of an annoyance and may in fact be desired, however, tailoring an advertisement requires information associated with the user that is often difficult to obtain since most users are very weary about providing personal or private information to third parties.

Given recent trends in advertisement tailoring and market segment targeting, experience shows that consumers are often willing to relinquish personal information in exchange for some value. Accordingly, delivering suitable utility to the consumer can provide a happy exchange for the information necessary to construct an efficient or accurate ad targeting model. However, advertising is merely a means to the end of increasing sales, so an advertiser ultimately desires converting advertising audiences into purchasing consumers. Yet the act of shopping (e.g., purchasing) has different connotations to different consumers. For example, while one individual might view shopping as an opportunity to locate bargains, another individual might prefer to pay a premium for the convenience of buying several items at a single location and/or quickly and efficiently.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture that can aggregate user information in order to provide personalized shopping route optimization. In accordance therewith, the architecture can employ machine learning techniques to tailor optimization models or parameters in accordance with a particular user. Hence, an optimized shopping route can vary amongst distinct users given that parameters for different individuals can be weighted differently. For example, a first shopping route can be optimized with a tendency toward, say, convenience such that waypoints are small in number or clustered together, while a second shopping route can be optimized, e.g., slanted toward bargains at various business establishments, even though both shopping routes include identical items on the purchase list.

One potentially unforeseen benefit of providing optimized shopping routes to users is access to a rich source of profile information that can be employed to develop a profile for a given user, which in turn can be employed continually and incrementally to improve results of route optimizations for users. For example, in order to provide a shopping route, the architecture typically needs to be apprised of the items that a user desires to purchase. Such a purchase list can be a rich source of profile information, as can the user's residential address, which, if input or otherwise known, can also aid optimization as well as in constructing an accurate profile. Numerous other examples exist, many of which are detailed herein.

Moreover, in addition to access to the foregoing sources of profile information, the architecture can also obtain business data generally related to items available for purchase. Appreciably, acquisition of business data can be employed to optimize the shopping route. Furthermore, this data can also be employed (in connection with an individualized profile) to determine criteria necessary for one business establishment to outperform a competitor for a coveted spot on the shopping route. Hence, according to an aspect of the claimed subject matter, the architecture can deliver solicitations to the business establishment to encourage a behavior or action that is likely to be both beneficial to and specifically tailored to goals of the user.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a block diagram of a computer implemented system that can aggregate user information in order to provide shopping route optimization.

FIG. 2 illustrates a block diagram of numerous examples of profile information.

FIG. 3 depicts a block diagram a system that can build or supplement a user profile by way of queries.

FIG. 4 illustrates a block diagram of a system that can aggregate business data, establish optimized shopping routes, and/or provide suitable advertisements.

FIG. 5 is a block diagram of a system that is arranged in a server configuration.

FIG. 6 illustrates a block diagram of a computer implemented system that is arranged in accordance with a client or device-implemented configuration.

FIG. 7 is an exemplary flow chart of procedures that define a method for facilitating shopping route optimization by employing and/or aggregating user information.

FIG. 8 is an exemplary flow chart of procedures that define a method for facilitating incremental development of a user profile.

FIG. 9 depicts an exemplary flow chart of procedures defining a method for utilizing additional data sources and/or additional features in connection with the optimized shopping route.

FIG. 10 illustrates a block diagram of a computer operable to execute the disclosed architecture.

FIG. 11 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. For example, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

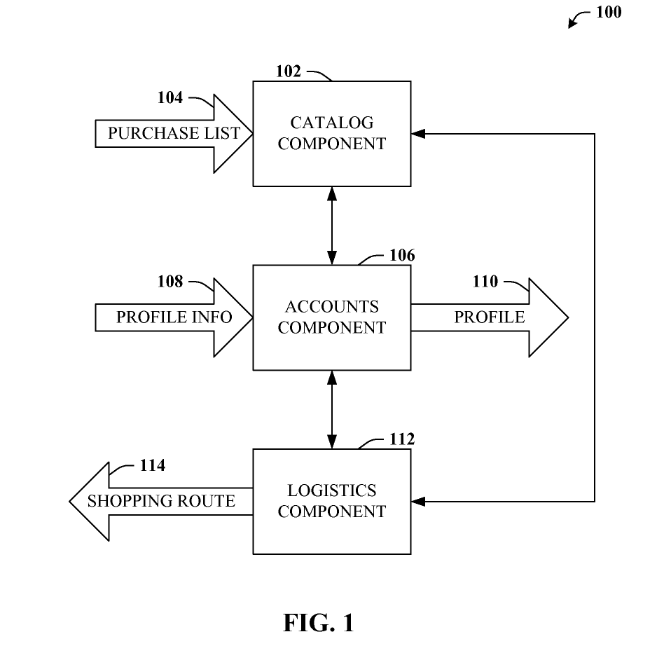

Referring now to the drawing, with reference initially to FIG. 1, computer implemented system 100 that can aggregate user information in order to provide shopping route optimization is depicted. Generally, system 100 can include catalog component 102 that can receive purchase list 104. Purchase list 104 can include, for example, a set of items designated for purchase by a user, wherein the items can be substantially any good or service. In addition to receiving purchase list 104, catalog component 102 can transmit information as well. For instance, catalog component 102 can communicate with or include a user interface (not shown) intended to provide easy, convenient, and/or efficient user input during creation of purchase list 104 or selection of the set of items included in the purchase list 104. Thus, catalog component 102 can include product data to aid in the described creation or selection. Product data can include elements such as item description, price, associated products or accessories, competing products, ratings or rankings, reviews, comparisons and the like. In addition, catalog component 102 can include features such as auto-completion (for words or terms), auto-correction, spelling suggestions, keyword search, hierarchical category selection or navigation, description matching, ambiguity resolution, translation services, intelligent and/or dynamic product feature selection, tagging for recurring or periodic purchase, and so on. Accordingly, catalog component 102 can facilitate more rapid or simpler generation of the purchase list 104 by a given user.

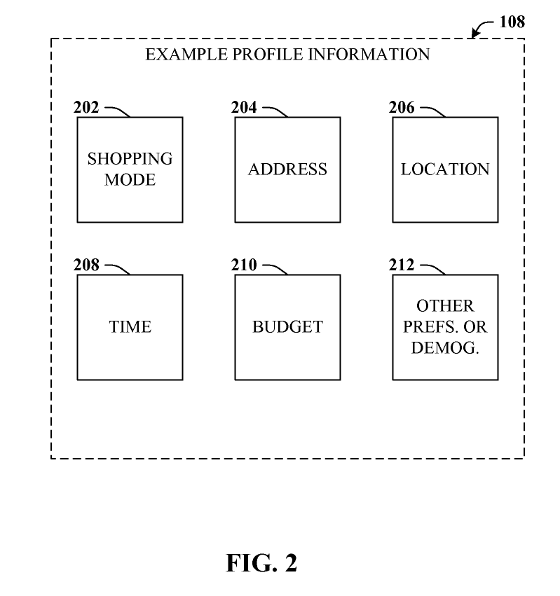

System 100 can also include accounts component 106 that can obtain profile information 108 associated with the user. In addition, accounts component 106 can employ profile information 108 in connection with profile 110 which can relate to the user. For example, accounts component 106 can employ profile information 108 to create profile 110 as well as to update profile 110. A number of non-limiting examples of suitable profile information 108 can be found with reference to FIG. 2 and the accompanying description provided infra.

In addition, system 100 can further include logistics component 112 that can employ purchase list 104 and profile information 108 to develop displayable optimized shopping route 114 in connection with purchase list 104. Shopping route 114 can be optimized in a variety of ways. For example, shopping route 114 can be substantially optimized based upon an efficient route or substantially optimized based upon a shortest path. As another example, shopping route 114 can be optimized based upon a price or a cost savings (potentially including travel costs, opportunity costs, etc.), wherein a price of an item on purchase list 104 can be given a greater weight than other factors such as distance or time. Numerous other examples are provided infra, however, it is to be appreciated that the manner in which logistics component 112 optimizes shopping route 114 can be configurable and/or preset by way of profile information 108 or profile 110.

While still referencing FIG. 1, but turning also to FIG. 2, numerous examples of profile information 108 can be found. It is to be appreciated that the following examples are intended to be illustrative in nature and, therefore, need not limit the scope of the appended claims to only those examples. Rather, it is readily apparent that other examples of profile information 108 can exist and can be deemed equally suitable for use with the claimed subject matter. In general, the examples of profile information 108 provided herein can be received by accounts component 106, typically transmitted or input by the user and/or inferred by logistics component 112. It should be understood that some types of profile information can be automatically obtained by accounts component 106, such as, for example, location (e.g., by way of Global Positioning System (GPS) or Wireless Application Protocol (WAP) devices).

As one example, the profile information 108 can be a shopping mode 202. Shopping mode 202 can relate to whether or not the user prefers value over convenience. For example, some individuals do not particularly enjoy shopping, and would generally prefer to satisfy any given purchase list 104 at a single location, or a small set of proximate locations, even if such a shopping mode 202 results in paying slightly higher prices. In contrast, other individuals can gain gratification from shopping, or might prefer to have hands-on experiences with and/or comparisons between items on purchase list 104, even if such shopping mode 202 results in a greater amount of time required in order to satisfy purchase list 104. Accordingly, shopping mode 202 can be parameter that distinguishes between these types of shopping behavior or preferences for a given user.

It is to be appreciated that the shopping mode 202 can be a discrete selection or value or a factor that is weighted based upon numeric ranges representing a continuous spectrum. It is to be further appreciated that shopping mode 202 can be dynamically inferred or weighted based upon shopping history (e.g., previous shopping patterns, previous user-selections, deviations from selections or patterns and so forth), time of day or day of the week (e.g. lunch hour versus weekend, likelihood of traffic congestion . . . ), items on purchase list 104 (e.g. items that require refrigeration such as milk or ice cream), and so on and so forth.

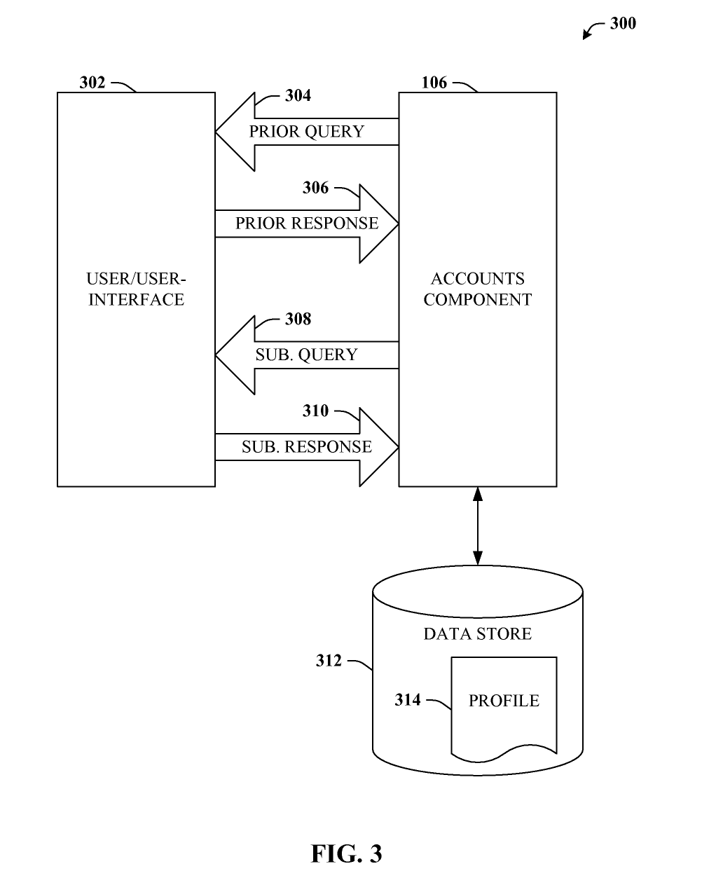

Another example type of profile information 104 can be address 204 such as the residential address of the user. Address 204 can be relevant information for optimizing shopping route 114 given that address 204 often indicates a point of origin as well as a final destination. Likewise, profile information 104 can include location 206 that can be, e.g. a current location of the user or a future or intended location of the user. For example, logistics component 112 might employ address 204 as a starting point for optimized shopping route 114 by default. However, if the user is currently at another location 206, then such location 206 can be employed instead as the initial position for optimized shopping route 114. Similarly, logistics component 112 might employ address 204 as the final destination by default as well, yet location 206 can also be a future or indented location of the user such that location 206 can represent the final destination or another waypoint on shopping route 114 that should be accommodated. It is to be appreciated that address 204 as well as location 206 can be determined by way of GPS, WAP, or another suitable means as well as by manual entry by the user. In addition, address 204 and location 206 can be saved to profile 110 for convenient access or recall at a later time, which is further described in connection with FIG. 3.

Profile information 108 can also include a time-based feature depicted as time 208. For example, time 208 can refer to a current time/date, a scheduled time (e.g., an anniversary, birthday, holiday, etc. before which a particular item should be purchased), as well as an amount of time allocated to a shopping session. For instance, the user can input a desired amount of time he or she intends to spend in fulfilling the purchase list 104, or in other cases, logistics component 112 can infer this property based upon, e.g. past behavior. Regardless, time 208 allocated to a shopping session can be relevant in determining optimized shopping route 114.

Additionally, profile information 108 can include budget 210 such as a budget for a particular shopping session. As with time 208, budget 210 can also be a relevant factor in optimizing shopping route 114. For example, some business establishments might be precluded based upon a higher cost of items on purchase list 104 relative to competitors. Similarly, one business establishment might receive a higher weight even though it is more distant from the user or other waypoints on shopping route 114.

Still another example type of profile information 108 can be shopping preferences and/or demographic data 212. As with other types of profile information 108, preferences/data 212 can be input by the user, received automatically from sensory components, and/or dynamically inferred based upon relevant data sets. One such example of preferences/data 212 can be purchase list 104 itself. For example, what, when, how often, where, or for whom an item is purchased can provide rich information about a user and can be employed to build or update profile 110, which, in turn, can be employed to enhance the results of shopping route 114. As another example, shopping preferences 212 can also relate to shopping route 114. For instance, a certain business establishments can be flagged to be omitted from shopping route 114 on an ongoing basis or based upon other criteria such as omitted during weekends or times it is known the business establishment will likely be overly crowded. Such preferences can be set previously or dynamically adjusted (e.g., by the user) upon inspection of shopping route 114.

In another aspect, address 204 can be employed as an indicator for demographic data 212, as can budget 210, or even the purpose of the purchase. For instance, a shopping history may imply that a user is very frugal when making purchases for herself, yet is lavish when purchasing for her child or her garden, which can be inferred, e.g., by certain occasions such as birthdays or holidays (provided by the time 208 feature) or based upon purchase list 104. Shopping preferences 212 can also be determined based upon a shopping history as can, say, location 206. For example, data can be collected that indicates most times a user frequents a local fish market, he subsequently visits to his mother's residence (e.g., location 206). Furthermore, shopping preferences 212 and/or shopping route 114 can also be affected by ordering such as when perishable items (e.g., ice cream) are on the list, or when several related or peripheral items are on the purchase list 104 (e.g. a shirt and a tie; a camera and a telephoto lens). In such a case, a waypoint for the primary, or in many cases the more expensive, item can be ordered on shopping route 114 prior to waypoints for accessories or peripherals in order to, e.g., prevent inefficiencies related to refunds or exchanges of the peripherals.

Still referring to FIGS. 1 and 2, it is to be appreciated that, as previously mentioned, all or a subset of profile information 108 can be received as direct input to accounts component 106 as well as dynamically inferred by logistics component 112. In addition, logistics component 112 can employ profile information 108 (as well as profile 110) in order to create other inferences, typically related to optimizing shopping route 114. Furthermore, in certain situations, profile information 108, shopping route 114, or other relevant information can be shared with business establishments, although such a feature can be restricted by the user if desired. One situation in which information-sharing can be beneficial to the user is transmitting a subset of purchase list 104 to respective businesses represented as waypoints on shopping route 114. Accordingly, it is conceivable that those businesses can earmark or prepare and ring-up the items in advance, allowing the user to simply arrive and pay. Businesses that provide such a service can be weighted more heavily (further detailed with reference to FIG. 3) when constructing optimized shopping route 114, especially to users who are profiled to prefer convenience.

It is to be further appreciated that shopping route 114 can be optimized based upon a particular feature such as travel distance, convenience, most cost effective route, as well as based upon a combination of numerous features, many of which are described herein. In particular, logistics component 112 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

With reference now to FIG. 3, there is illustrated computer implemented system 300 that can build or supplement a user profile by way of queries. Generally, system 300 can include accounts component 106 that can obtain profile information 108 associated with user 302 in order to generate or update profile 110 for user 302. In addition to what has been described supra and/or in order to provide further detail of additional features, accounts component 106 can transmit a set of queries 304, 306 to user/user-interface 302 as well as receive a set of responses 306, 310 from user 302. Accordingly, portions of profile information 108 need not be directly input by user 302 as part of a form or questionnaire, which some individuals dislike due to the hassle. Rather, some of profile information 108 can be obtained by providing short, simple queries (e.g., query 304), and receiving response 306, typically in the form of a “yes” or “no” style input.

Moreover, by fragmenting the acquisition of certain profile information 108 employed to build profile 110, profile 110 can be incrementally developed over time and compared with other data sources (e.g. patterns, history, demographics . . . ) to establish consistency or relevance. Hence, acquisition of such profile information 108 (e.g., by way of response 306) can be relatively painless for user 302 to provide, as a single keystroke is often all that is necessary. Moreover, determinations or inferences can be made as to which type of query 304 will be delivered to user 302 so as to optimize the validity or other characteristics associated with profile 110, to fill in high priority gaps determined to exist in profile 110, to resolve ambiguities extant in profile 110, as well as to allow profile 110 to evolve over time in response to associated changes in the user 302 or a user's behavior, patterns, or preferences.

It is to be appreciated that the aforementioned queries can be transmitted either before or after optimized shopping route 114 has been created or delivered to user 302. In the former case, prior query 304 is intended to solicit prior response 306, which is generally more useful for creating shopping route 114. In the latter case, subsequent query 308 can be transmitted after user 302 has been apprised of optimized shopping route 114, thus, subsequent responses 310 are typically directed more toward feedback, quality control, or supplementing profile 110, which, along with any other suitable information can be stored for later recall in a data store 312.

Various examples of queries 304, 306 can include, but are not limited to examples found in Table I infra.

TABLE I

| Query | Type | Primary Relationships |
|---|---|---|
| Do you prefer to do all shopping at a single | Prior | Shopping mode 202, Time 208 |
| location, even when you know some of the items | | |
| will be cheaper elsewhere? | | |
| Are the dress and the shoes on your purchase list | Prior | Shopping route 114: ordering or |
| intended to match? | | aggregation |
| On a scale from 0-9 how frugal do you consider | Either | Shopping mode 202, Budget 210 |
| yourself to be? | | |
| Do you often know in advance how much time or | Either | Shopping mode 202, Time 208, |
| money you want to spend for a particular | | Budget 210 |
| shopping outing? | | |
| Do you often stick to a budget or time constraint | Either | Shopping mode 202, Other 212 |
| once set? | | |
| Did you locate all the items on your list? | Sub. | Profile 110, Business data 404 |
| Did this item meet your expectations? | Sub | Profile 110, Business data 404 |

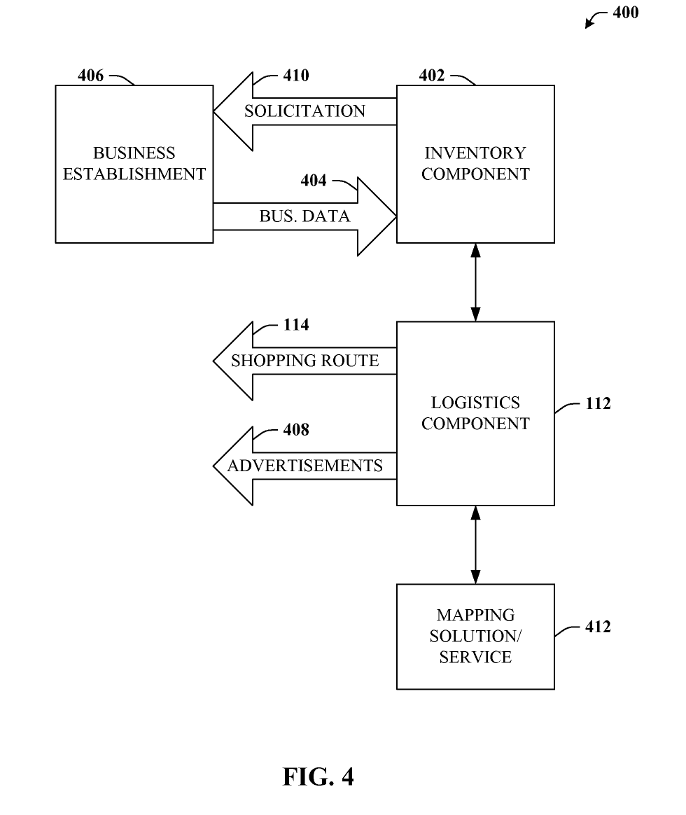

Referring now to FIG. 4, computer implemented system 400 that can aggregate business data, establish optimized shopping routes, and/or provide suitable advertisements is depicted. To the accomplishment of the foregoing and other related ends, system 400 can include inventory component 402 that can receive business data 404, wherein business data 404 can relate to items available for purchase. Hence, business data 404 can include a list of products, corresponding prices, descriptions, features, sales or incentives, advertisements, store location, position of the item within the store, as well as other suitable information. All or portions of business data 404 can be received directly from various business establishments 406 as well as from other sources such as databases, directories, advertisements or marketing, and so forth. Although not expressly illustrated, inventory component 402 can be coupled to or be a component of catalog component 102, and can further be coupled to data store 312 such that business data 404 can also be saved therein, along with data relating to profiles 110.

Furthermore, system 400 can include logistics component 112 that can employ purchase lists 104, profiles 110, or profile information 108 in order to develop optimized shopping route 114, which can be delivered to user/user-interface 302 as substantially described supra. In addition, logistics component 114 can further employ business data 404 to optimize shopping route 114. In accordance with one aspect of the claimed subject matter, logistics component 112 can determine or infer the relevance and/or suitability of certain advertisements 408. Those advertisements 408 that are deemed to be relevant or suitable can be transmitted along with shopping route 114, or in other aspects packaged, bundled, or embedded in shopping route 114.

For example, consider the case in which shopping route 114 is optimized for convenience (e.g., shortest distance, least amount of stops, least amount of time spent for a shopping session, etc.) in accordance with a user's preferences, selections, or inferences thereof. One suitable advertisement 408 that can accompany shopping route 114 is an advertisement 408 that indicates that although shopping route 114 has been optimized based upon a convenience setting, user 302 should be aware that by making an additional stop and proceeding, say, 2.1 miles beyond one of the waypoints of shopping route 114, a cost savings of $35 can be gained on the television listed in purchase list 104. As another example, advertisement 408 can indicate that no additional stops would be necessary as all items on the purchase list can be purchased at a second location that, while, say, 6 miles farther in distance, the traffic conditions may be lighter at this time of day and an overall cost savings can be obtained for all items on the purchase list. In the preceding cases, logistics component 112 can find example advertisement 408 more or less relevant or suitable based upon the price or value of the item. For instance a cost savings of $1 might not be appropriate for interjecting advertisement 408 or diverting the attention of user 302, while a greater monetary amount might be, and this determination can be inferred by logistics component 112 based upon data and/or models described herein. Moreover, advertisement 408 can be selected based upon a pricing or bidding model provided to business establishments 406, or can be selected by virtue of a score that is very close to optimal (e.g., advertisement 408 can relate to a product or establishment 406 that might otherwise have been extant on shopping route 114 but for a slight change in user profile 110).

In accordance with another aspect of the claimed subject matter, inventory component 402 can communicate solicitation 410 to one or more business establishments 406. Solicitation 410 can, but typically will not, include shopping route 114, as this can be considered private information by user 302. Generally, solicitation 410 will include a set of criteria necessary to modify shopping route 114 to include business establishment 406. For example, while logistics component 112 might already have calculated optimized shopping route 114 based upon currently available data, inventory component 402 can transmit solicitation 410 to certain business establishments 406 and await a response before providing shopping route 114 to user 302. Thus, shopping route 114 ultimately supplied to user 302 can be altered based upon a willingness of business establishment 406 to meet the criteria included in solicitation 410, and thus generally provide a better value or more convenience to user 302.

In accordance with the foregoing, business establishment 406 can, for example, indicate that if user 302 agrees to purchase all or portions of the items on the purchase list from the establishment 406, then a certain discount or other incentive will be provided to user 302, as well as the convenience of a single location. Thus, logistics component 112 can provide to user 302 a first shopping route 114 that was constructed based upon data prior to solicitation 410 and further provide the terms articulated by the business establishment 406 in the form of advertisement 408, as well as, optionally, a second shopping route 114 that includes the business establishment 406 providing the incentive. Hence, logistics component 112 can provide all or portions of or combinations of: the original shopping route 114, the modified the shopping route 114, or an advertisement 408 based upon responses to solicitation 410. It should be appreciated that the business establishments 406 for which solicitations 410 are delivered may be (but need not necessarily be) limited by a particular type of membership or affiliation with the host that provides or maintains inventory component 402. It should also be appreciated that logistics component 112 can employ either or both new or extant mapping solutions/services 412 in order to construct optimized shopping routes 114.

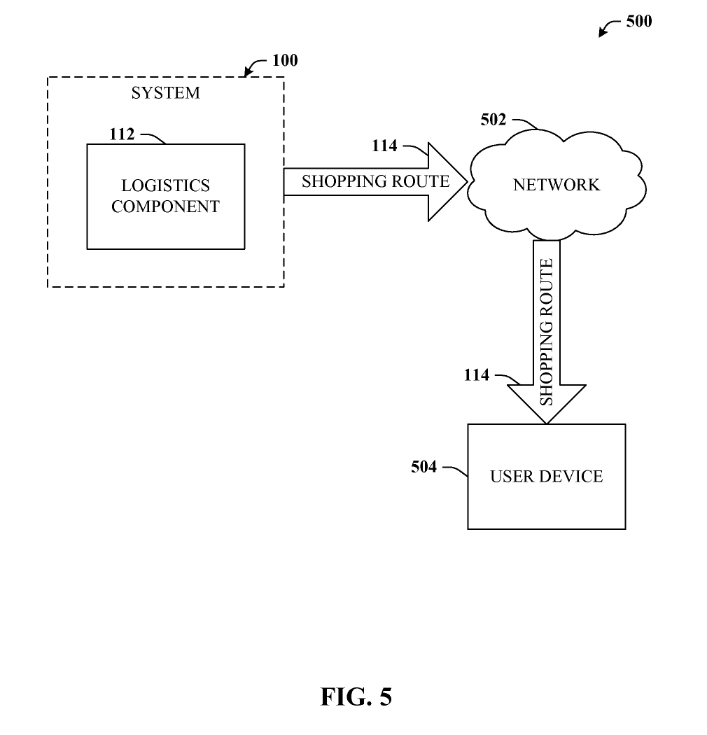

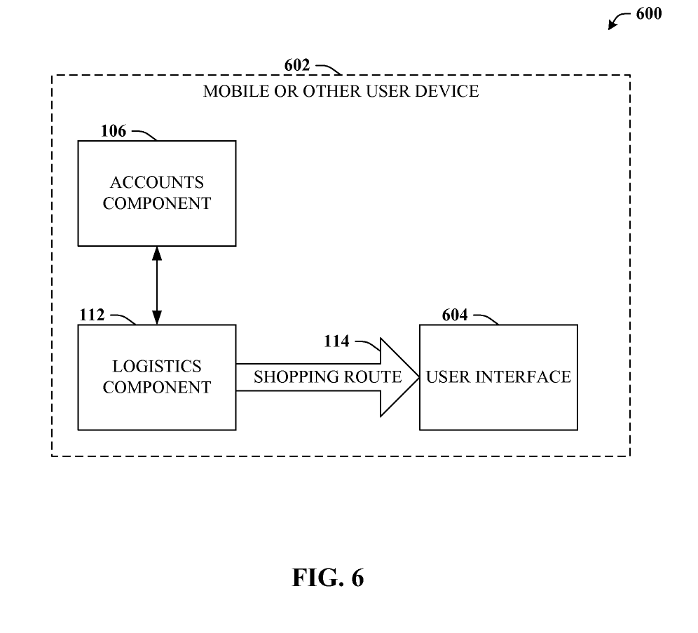

FIGS. 5 and 6 illustrate various configurations for the claimed subject matter. In particular, FIG. 5 illustrates system 500 that is arranged in a server configuration in accordance with the claimed subject matter, whereas FIG. 6 displays system 600 that is arranged in accordance with a client or device-implemented configuration. System 500 can include all or portions of system 100, specifically logistics component 112. In addition, system 500 can be operatively coupled to network 502, which can be a computer-based network such as a the Internet or another wide area network (WAN), and typically, the communications described herein (e.g., shopping route 114, et al.) with user device 502 (or user 302) are propagated over network 502. One advantage of such a configuration can be access to more robust, more predictable, more sophisticated, or more uniform resources such as storage capacity, processing power, bandwidth, hardware, software, or other relevant features, as well access to a richer reservoir of data, as any of these resources can be centralized, aggregated, and/or secured.

In contrast, system 600 provides for all or portions of system 100, most notably logistics component 112 and/or accounts component 106, to exist as components of user device 602. User device 602 can be, e.g., a personal computer, workstation, gaming console or the like. In addition, user device 602 can be a mobile device, which can include substantially any portable electronic device such as phones, smart phones, laptops, tablets, media players/recorders, Personal Digital Assistants (PDAs), cameras, games, fobs, and so on. Mobile user device 602 can be a handheld device as well as wearable device and generally includes suitable hardware for displaying shopping route 114 (e.g., user interface 604) as well as one or more types of wireless communication such as cellular, wireless fidelity (WiFi), Bluetooth, Near Field Communication (NFC), Radio Frequency Identification (RFID), etc.

One potentially unforeseen advantage of a client-side configuration can be that certain potentially private information (e.g., profile 110, profile information 108, or shopping route 114) need not ever be propagated over a public or insecure network (e.g., network 502), or shared with an advertiser or other third party. Rather, according to one aspect of the claimed subject matter, user device 602 can prevent external access to profile 110, profile information 108, as well as shopping route 114.

Moreover, another advantage facilitated by the use of mobile devices can be that shopping route 114 can be dynamically updated and/or modified. For example, items can be added or removed from purchase list 104 during the shopping session. In addition, a request to modify shopping route 114 can be submitted such as when user 302 notices there is an accident on a freeway recommended by shopping route 114. Furthermore, the request to modify shopping route 114 can include adding or removing a waypoint. For instance, user 302 might decide or agree to pick up a friend before completing the shopping session (e.g. adding a waypoint) or learn there is no need to pick up a child after practice (e.g., removing a waypoint) as a spouse of user 302 has taken over this responsibility. In any case, it is to be appreciated that shopping route 114 can be updated in real time to account for new constraints, which can be especially useful when utilizing a mobile device.

Regardless of the topology or configuration, it is to be appreciated and understood that the claimed subject matter can provide a unique opportunity to promote the use of mobile devices (e.g. user device 504, 602) for making purchases, which can facilitate numerous benefits to the parties involved. For example, purchasing items on purchase list 104 (as well as others) can be much more convenient for user 302 by, e.g. avoiding check-out lines. Likewise, such behavior can result in cost savings to business establishment 406 given fewer sales employees may be required. In addition, purchases can be verified, profile information 108 and/or profile 110 can be enriched, and a wide range of other data aggregations and market targeting techniques can also be employed when mobile devices are used for purchasing.

Furthermore, also irrespective of the configuration, displayable optimized shopping route 114 can include seamless-transition, multi-scale views. Hence, displayable optimized shopping route 114 can include objects such as trade cards that can facilitate multi-scale zooming or “dives”. Such a feature can be implemented by way of technologies or techniques identical or similar to Photosynth-brands technology, Seadragon-brands technology, Seahorse-brands technology, as well as any other suitable technologies. It is worthwhile to underscore that the seamless-transition, multi-scale views can generally be provided irrespective of the type of client device 504, 602 or associated user interface.

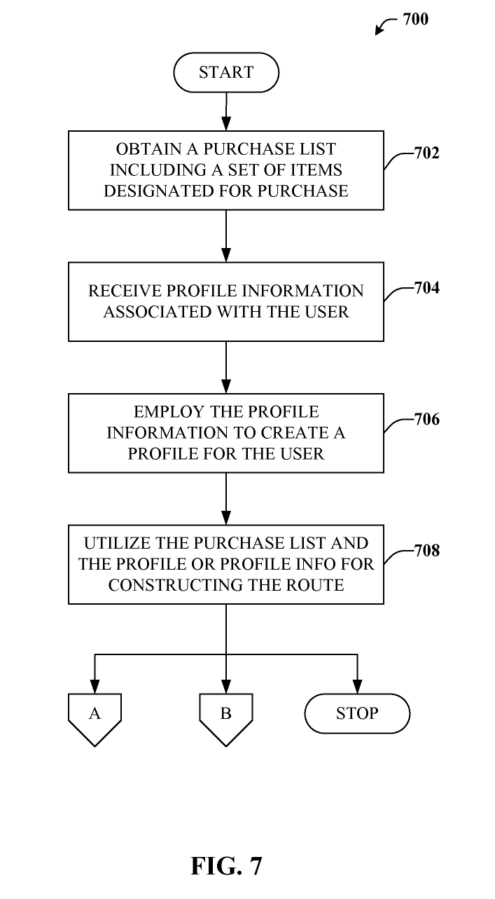

FIGS. 7, 8, and 9 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 7, exemplary computer implemented method 700 for facilitating shopping route optimization by employing and/or aggregating user information is illustrated. Generally, at reference numeral 702, a purchase list can be obtained, wherein the purchase list can include a set of items designated for purchase by a user. It is to be understood that the set of items included in the purchase list can be substantially any good or service, and, moreover, the set of items generally reflect goods or services the user intends to purchase within a single shopping session.

At reference numeral 704, profile information relating to or associated with the user can be received. It is to be understood that the profile information can include, but is not necessarily limited to, a shopping mode (e.g., convenience, value . . . ) of the user, a residential address of the user, a current location of the user, a future or intended location of the user, an amount of time allocated to a shopping session, a budget for a shopping session, as well as a wide-range of other appropriate preferences or demographic data. It is to be appreciated that all or portions of the profile information can be input by the user, can be obtained automatically from suitable devices or services, or can be dynamically or incrementally inferred based upon relevant data sets.

At reference numeral 706, the profile information can be employed to create or update a profile for the user. Both the profile information and the profile can be stored to a data store for later recall, reference, and/or access. At reference numeral 708, the purchase list can and at least one of the profile information or the profile can be utilized for constructing a displayable optimized shopping route associated with the purchase list. For instance, the shopping route can include one or more locations that have available for purchase all or a subset of the items included in the purchase list, and, moreover, the route can be optimized with respect to information known about a particular user.

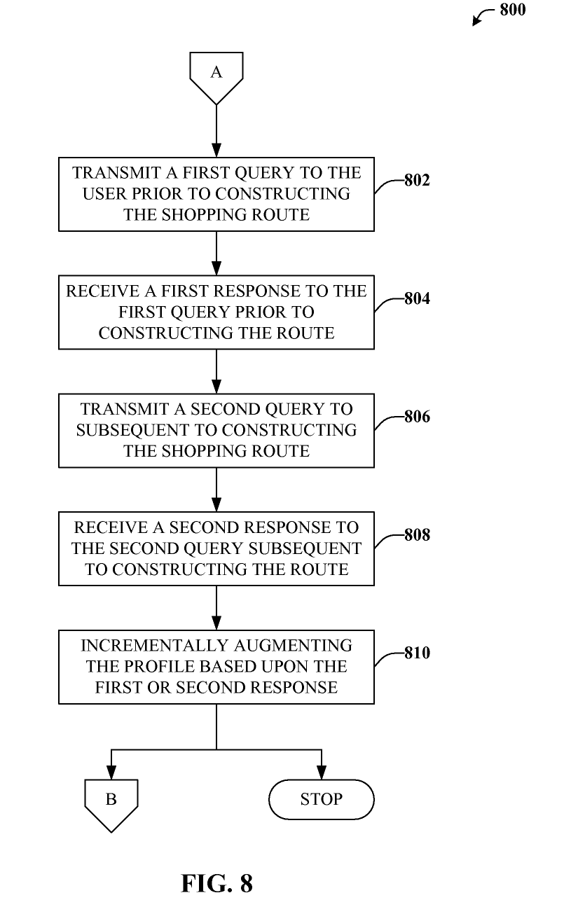

With reference now to FIG. 8, an exemplary computer implemented method 800 for facilitating incremental development of a user profile is portrayed. In general, at reference numeral 802, a first query can be transmitted to the user prior to constructing the shopping route. In more detail, the first query can be transmitted prior to the acts described at reference numeral 708 of FIG. 8. Reference numeral 804 details an act of receiving a response to the first query prior to constructing the shopping route. By receiving the response to the first query prior to constructing the shopping route, information included in or inferred from the response can be further employed for constructing the shopping route in a more optimized or more personalized manner.

In a similar fashion, at reference numeral 806, a second query can be transmitted to the user subsequent to constructing the shopping route, and at reference numeral 808, a response to the second query can be received subsequent to constructing the shopping route. Typically, queries and responses that are communicated prior to constructing the shopping route can relate to optimization, whereas those communicated subsequent to the construction tend to relate to feedback. However, such is not always the case, and, moreover, both types of queries and responses can deal with aspects of personalization and/or profile building, as can be seen with reference to act 810. At reference numeral 810, the profile can be augmented incrementally based upon responses to either or both the prior query or the subsequent query.

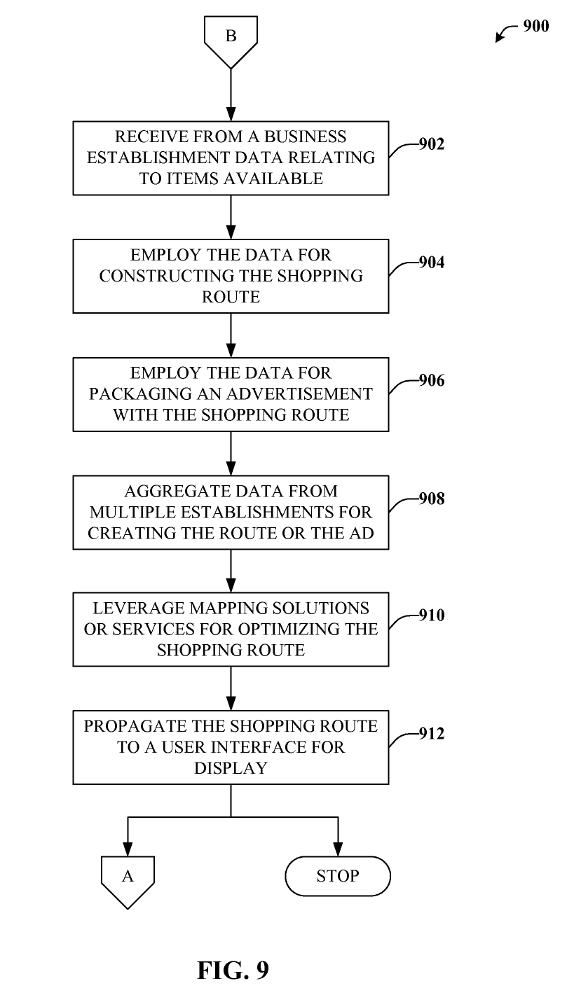

Turning briefly to FIG. 9, an exemplary method 900 for utilizing additional data sources and/or additional features in connection with the optimized shopping route is illustrated. At reference number 902, business data relating to items available for purchase can be received from a business establishment. The business data can include, yet is not necessarily limited to, a list of products, corresponding prices, descriptions, features, sales or incentives, advertisements, store location, position of the item within the store, as well as similar or other suitable information. At reference numeral 904, the data received at act 902 can be employed in addition to the profile information and profile for constructing the shopping route.

At reference numeral 906, the business data can be employed for packaging an advertisement with the shopping route. For example, while the shopping route may include a waypoint relating to a particular business establishment, the advertisement can be for a competitor that could potentially replace that waypoint, but only if certain initial criterion employed for constructing the shopping route were to change. Thus, the advertisement may simply be for a competitor who can provide very similar utility to the user, but fell short, so the advertisement is serving as a means of providing an alternative to the user (for which the user's choice can provide additional information to reinforce or modify the profile). As another example, the advertisement might change certain initial criteria by providing an incentive to the user. Thus, while prior to shopping route construction one business establishment was selected as a waypoint, after considering the new incentive, the competitor might be more suitable for that waypoint. Hence, the shopping route can be automatically adjusted or the advertisement can accompany the original route to provide an additional option to the user.

At reference numeral 908, business data can be aggregated from multiple business establishments. This aggregated data can be employed for constructing the shopping route as well as for packaging the advertisement, as substantially described supra. At reference numeral 910, a mapping solution or service can be leveraged for optimizing the shopping route. It is to be appreciated that the mapping solution/service can be designed specifically for the claimed subject matter as well as potentially be an extant solution/service. At reference numeral 912, the shopping route can be propagated to a user interface for display. It should be appreciated and understood that such propagation can exist between two coupled components of a device or in other cases propagated by way of a computer network.

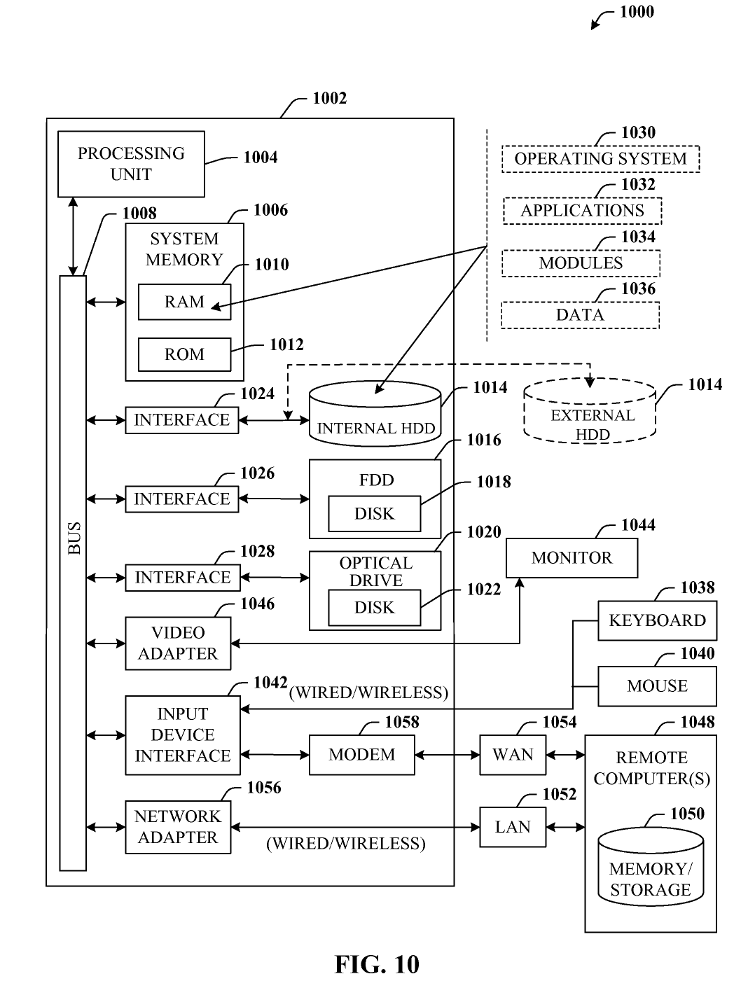

Referring now to FIG. 10, there is illustrated a block diagram of an exemplary computer system operable to execute the disclosed architecture. In order to provide additional context for various aspects of the claimed subject matter, FIG. 10 and the following discussion are intended to provide a brief, general description of a suitable computing environment 1000 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the claimed subject matter includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g. a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g. a wide area network (WAN) 1054. Such LAN and WAN networking environments are commonplace in offices and companies, and facilitate enterprise-wide computer networks, such as intranets, all of which may connect to a global communications network, e.g. the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

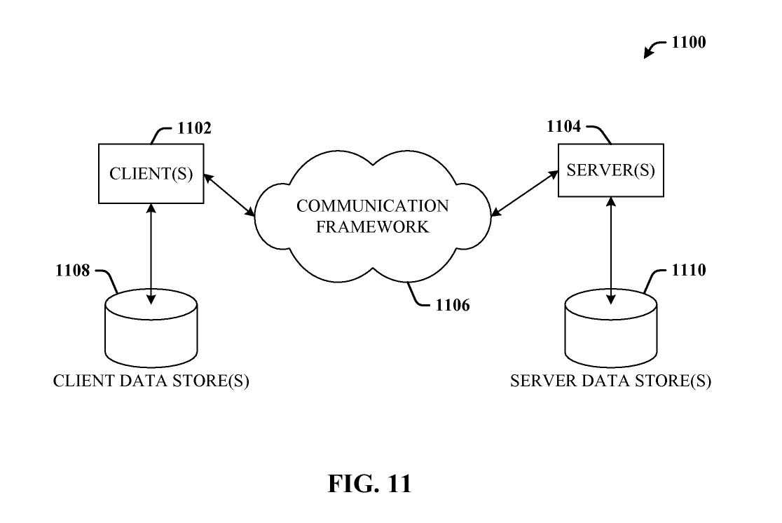

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the claimed subject matter, for example.

The system 1100 also includes one or more server(s) 1104. The server(s) 1104 can also be hardware and/or software (e.g., threads, processes, computing devices). The servers 1104 can house threads to perform transformations by employing the claimed subject matter, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer-implemented system that aggregates user information in order to provide shopping route optimization, comprising:
a catalog component that receives a purchase list that includes a set of items designated for purchase by a user;
an accounts component that obtains profile information associated with the user and that employs the profile information to generate a profile for the user; and
a logistics component that employs the purchase list and the profile information to develop a displayable optimized shopping route in connection with the purchase list.

2. The system of claim 1, the profile information includes a shopping mode of the user, the shopping mode ranges from convenience to value.

3. The system of claim 2, the profile information further includes at least one of an address of the user, a current location of the user, a future or intended location of the user, an amount of time allocated to a shopping session, a budget for a shopping session, shopping preferences, or demographic data.

4. The system of claim 1, the accounts component transmits a query and receives a response to the query prior to development of the shopping route in order to determine or infer a portion of the profile information.

5. The system of claim 1, the accounts component transmits a query and receives a response to the query subsequent to development of the shopping route in order to update the profile.

6. The system of claim 1, the accounts component incrementally builds the profile based upon responses to queries submitted to the user.

7. The system of claim 1, further comprising an inventory component that receives business data from business establishments, the data relates to items available for purchase.

8. The system of claim 7, the logistics component further employs the business data to optimize the shopping route.

9. The system of claim 7, the logistics component further employs the business data to supply an advertisement in connection with the shopping route.

10. The system of claim 7, the logistics component transmits a solicitation to the business establishment, the solicitation includes a set of criteria necessary to modify the shopping route to include the business establishment.

11. The system of claim 1, the shopping route includes multiple or many business establishments, optimized based upon value, or the shopping route includes a single or a small number of business establishments, optimized based upon convenience

12. The system of claim 1, the logistics component leverages extant mapping solutions or services to optimize the shopping route.

13. The system of claim 1, the logistics component propagates the displayable optimized shopping route to a user-interface for display of the shopping route.

14. The system of claim 13, the displayable optimized shopping route includes seamless-transition multi-scale views of the shopping route.

15. The system of claim 1 is a mobile device that displays the shopping route prevents external access to the profile and/or the profile information.

16. The system of claim 1 is a server coupled to one or more networks.

17. A computer-implemented method for facilitating shopping route optimization by employing and/or aggregating user information, comprising:
obtaining a purchase list, the purchase list including a set of items designated for purchase by a user;
receiving profile information associated with the user;
employing the profile information to create a profile for the user; and
utilizing the purchase list and at least one of the profile information or the profile for constructing a displayable optimized shopping route associated with the purchase list.

18. The method of claim 17, further comprising at least one of the following acts:
transmitting a first query to the user prior to constructing the shopping route;
receiving a first response to the first query prior to constructing the shopping route;
transmitting a second query to the user subsequent to constructing the shopping route;
receiving a second response to the second query subsequent to constructing the shopping route; or
augmenting incrementally the profile based upon at least one of the first or the second response.

19. The method of claim 17, further comprising at least one of the following acts:
receiving from a business establishment data relating to items available for purchase;
employing the data for constructing the shopping route;
employing the data for packaging an advertisement with the shopping route;
aggregating data from multiple business establishments for at least one of constructing the shopping route or packaging the advertisement;
leveraging a mapping solution or service for optimizing the shopping route; or
propagating the shopping route to a user interface for display.

20. A computer-implemented system for aggregating user information and for providing shopping route optimization, comprising:
computer-implemented means for receiving a purchase list, the purchase list including a set of items designated for purchase by a user;
computer-implemented means for obtaining profile information relating to the user;
computer-implemented means for utilizing the profile information to develop a profile for the user; and
computer-implemented means for employing the purchase list and at least one of the profile information or the profile for building a displayable optimized shopping route associated with the purchase list.
